(19) United States
(12) Patent Application Publication
(10) Pub. No.: US 2026/0367416 A1
(43) Pub. Date: Nov. 19, 2026

(54) LIGHT-FIELD DISPLAY APPARATUS

(71) Applicant: BOE TECHNOLOGY GROUP CO., LTD., Beijing (CN)

(72) Inventors: Yujie Liu, Beijing (CN); Pengxia Liang, Beijing (CN); Fang Cheng, Beijing (CN)

(73) Assignee: BOE TECHNOLOGY GROUP CO., LTD., Beijing (CN)

(21) Appl. No.: 18/995,970

(22) PCT Filed: Feb. 6, 2024
(86) PCT No.: PCT/CN2024/076317

§ 371 Date: Jan. 17, 2025

(30) Foreign Application Priority Data
Mar. 13, 2023 (CN) 202310264973.5

(51) Int. Cl. G02B 30/10; G02B 3/00

(52) U.S. Cl. CPC G02B 30/10; G02B 3/005; G02B 3/0062

(57) ABSTRACT

A light-field display apparatus is provided, including: a display panel, provided with a plurality of sub-pixels arranged in an array, and used for emitting a plurality of light rays having different image information respectively; a first optical element, located on a light-emitting side of the display panel and causing the plurality of light rays emitted by the display panel to form a plurality of virtual viewpoints that enable focusing with one eye; and a second optical element, provided on a side of the first optical element away from the display panel and used for modulating light rays emerging from the first optical element to form a plurality of viewpoints in a human eye

### CROSS-REFERENCE TO RELATED APPLICATION

The present application claims a priority to the Chinese patent application No. 202310264973.5 filed in China on Mar. 13, 2023, a disclosure of which is incorporated herein by reference in its entirety.

### TECHNICAL FIELD

The present disclosure relates to the field of display product manufacturing technologies, and in particular to a light-field display apparatus.

### BACKGROUND

In conventional near-eye display, a 3D object displays different images to left and right eyes of a user to form three-dimensional vision. 3D display formed based on three-dimensional vision of human eyes causes a vergence-accommodation conflict. The vergence-accommodation conflict leads to visual fatigue and dizziness. How to resolve the vergence-accommodation conflict becomes a pressing problem to be resolved. One-eye light-field display can resolve this problem, but has low resolution.

### SUMMARY

To resolve the foregoing technical problems, the present disclosure provides a light-field display apparatus, to resolve the problem of how to resolve a vergence-accommodation conflict and improve resolution.

To achieve the foregoing objective, the technical solution used in embodiments of the present disclosure is a light-field display apparatus, including:
a display panel, provided with a plurality of sub-pixels arranged in an array, and used for emitting a plurality of light rays having different image information respectively;
a first optical element, located on a light-emitting side of the display panel and causing the plurality of light rays emitted by the display panel to form a plurality of virtual viewpoints that enable focusing with one eye; and
a second optical element, provided on a side of the first optical element away from the display panel and used for modulating light rays emerging from the first optical element to form a plurality of viewpoints in a human eye, to improve resolution of the viewpoints.

Optionally, the second optical element is a lens, a focal length F of the lens is obtained by using the following formula:

$$tan \frac{FOV}{2} = \frac{\frac{PanelSize}{2}}{F} ,$$

where FOV is a field of view, and PanelSize is a size (a width or a length) of the display panel.

Optionally, the lens may be a spheric lens, an aspheric lens, an optical path folding lens, or a Fresnel lens.

Optionally, the first optical element includes a microlens array.

Optionally, the first optical element includes a first cylindrical lens unit and a second cylindrical lens unit stacked in a light-emitting direction of the display panel, the first cylindrical lens unit includes a plurality of cylindrical lenses arranged in a first direction, the second cylindrical lens unit includes a plurality of cylindrical lenses arranged in a second direction, and an orthographic projection of the first direction on the display panel intersects with an orthographic projection of the second direction on the display panel.

Optionally, a field of view θ of each of microlenses or the cylindrical lenses satisfies the following formula:

$$tan \frac{θ}{2} = \frac{\frac{eyebox}{2}}{F} .$$

Optionally, an aperture of the microlens is D=n*p, where n is a quantity of viewpoints, and p is a sub-pixel spacing.

Optionally, a focal length f of the microlens is determined by using the following formula:

$$tan \frac{θ}{2} = \frac{\frac{D}{2}}{f} ,$$

where θ is the field of view of the microlens or the cylindrical lens, and D is the aperture of the microlens; and
a distance between the display panel and the microlens or the cylindrical lens is the focal length of the microlens or a focal length of the cylindrical lens.

Optionally, a distance a between the first cylindrical lens unit or the second cylindrical lens unit and the lens satisfies the following formula:

$$\frac{1}{a} - \frac{1}{b} = \frac{1}{F} ,$$

where F is the focal length of the lens, b is a depth of field corresponding to the first cylindrical lens unit or the second cylindrical lens unit, and a value of b ranges from 500 mm to 1500 mm.

Optionally, a diameter of a single one of the viewpoints is less than a distance between two adjacent viewpoints.

Beneficial effects of the present disclosure are as follows: through the arrangement of the first optical element, focusing with one eye can be implemented, thereby resolving a vergence-accommodation conflict, and the first optical element and the second optical element can improve resolution of viewpoints in a human eye.

### BRIEF DESCRIPTION OF THE DRAWINGS

FIG. 1 is a schematic diagram of occurrence of a vergence-accommodation conflict;

FIG. 2 is a schematic diagram of an image point and a focal point being at a same position without occurrence of a vergence-accommodation conflict;

FIG. 3 is a first schematic structural diagram of a light-field display apparatus according to an embodiment of the present disclosure;

FIG. 4 is a second schematic structural diagram of a light-field display apparatus according to an embodiment of the present disclosure;

FIG. 5 is a schematic diagram of a light path according to an embodiment of the present disclosure;

FIG. 6 is a schematic diagram of a relationship among a quantity of viewpoints, a size of a light spot of a viewpoint in a human eye, and a distance between adjacent light spots; and

FIG. 7 is a schematic diagram of a relationship between a depth of field of a first cylindrical lens unit and a distance between the first cylindrical lens unit and a lens, and a relationship between a depth of field of a second cylindrical lens unit and a distance between the second cylindrical lens unit and the lens.

### DETAILED DESCRIPTION

To make the objectives, technical solutions, and advantages of the embodiments of the present disclosure clearer, the following clearly and completely describes the technical solutions in the embodiments of the present disclosure with reference to the accompanying drawings in the embodiments of the present disclosure. Apparently, the described embodiments are merely some embodiments of the present disclosure rather than all of the embodiments. All other embodiments obtained by persons of ordinary skill in the art based on the described embodiments of the present disclosure fall within the protection scope of the present disclosure.

In the description of the present disclosure, it needs to be noted that orientation or location relationships indicated by terms “center”, “up”, “down”, “left”, “right”, “vertical”, “horizontal”, “inside”, “outside”, and the like are based on orientation or location relationships shown in the accompanying drawings, and are only used to facilitate description of the present disclosure and simplify description, but are not used to indicate or imply that the apparatuses or elements must have specific orientations or are constructed and operated by using specific orientations, and therefore, cannot be understood as a limitation to the present disclosure. In addition, the terms “first”, “second”, and “third” are used only for description, but are not intended to indicate or imply relative importance.

A vergence function converges lines of sight of two eyes onto a same object, and at the same time an accommodation function also focuses on the object at a same distance. As time passes, the brain is already used to the law that a line-of-sight and a focal point are always at a same position. However, during watching of a 3D movie, a distance between a viewer and a screen remains unchanged, and therefore a focal length is not changeable. As a result, the accommodation function cannot perform focusing at the distance suggested by the vergence function as usual. This breaks the long-lasting law, and positions resulting from vergence and accommodation are separated, which is a vergence-accommodation conflict. Due to the vergence-accommodation conflict, the brain is forced to synthesize information in which a line-of-sight and a focal point are not at a same position, which as a result confuses the brain, and further causes visual fatigue, dizziness, headaches, and other adverse reactions over a long period of time. Referring to FIG. 1, a left eye watches an actual light-emitting point A of the screen, and a right eye watches an actual light-emitting point B of the screen, and an image point resulting from fusion of images perceived by the left and right eyes is M. Focusing positions of the left and right eyes are different from the position resulting from the fusion, causing a vergence-accommodation conflict.

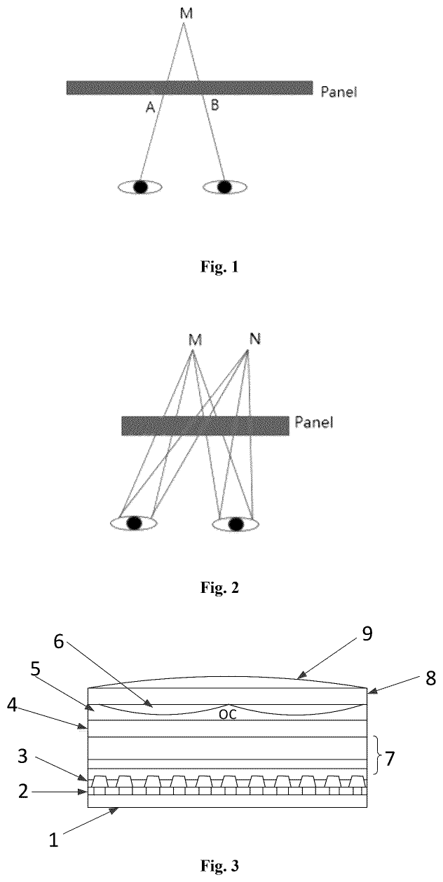

The vergence-accommodation conflict can be resolved through a one-eye light-field, making an image point and a focal point overlap. Referring to FIG. 2, a left eye watches an image point M, and fusion (of two viewpoints) is implemented through two pixels on a display panel. A right eye watches an image point N, and fusion (of two viewpoints) is implemented through two pixels on the display panel. The left and right eyes respectively focus on the image points M and N, and therefore a vergence-accommodation conflict does not occur. However, in a light-field display solution implemented based on a microlens array, light rays emitted by each pixel on the display panel are mainly collimated by using the microlens array into one light ray to generate a light ray field, and numerous light rays in the real word are simulated and restored by using this light ray field to implement light-field display. A display effect is better when a quantity of restored light rays is larger. However, more light rays can be restored only when the display panel has higher resolution. Therefore, the display panel needs to have very high resolution for this light-field display solution. Moreover, every light ray is obtained through collimation by a microlens. In other words, a diameter of the light ray is an aperture of the microlens, and resolution of a two-dimensional image displayed by the display panel is also the aperture of the microlens. As a result, display resolution of this technique is not high, and a three-dimensional display effect is poor.

In view of the foregoing problems, an embodiment provides a light-field display apparatus, including:
a display panel, provided with a plurality of sub-pixels arranged in an array, and used for emitting a plurality of light rays having different image information respectively;
a first optical element, located on a light-emitting side of the display panel and causing the plurality of light rays emitted by the display panel to form a plurality of virtual viewpoints that enable focusing with one eye; and
a second optical element, provided on a side of the first optical element away from the display panel and used for modulating light rays emerging from the first optical element to form a plurality of viewpoints in a human eye, to improve resolution of the viewpoints.

The plurality of virtual viewpoints that enable focusing with one eye may be formed through the first optical element. That is, one pupil can obtain at least two images having a three-dimensional display effect, so that a focusing distance of one pupil to at least two images obtained through at least two viewpoints in a visible range of the pupil can be consistent with a line-of-sight vergence distance when two pupils obtain respective images with a three-dimensional effect through at least two viewpoints in visible ranges of the corresponding pupils, thereby resolving dizziness and discomfort of an observer in a parallax 3D technique. Resolution of viewpoints in a human eye improved through the cooperation of the first optical element and the second optical element.

In an exemplary implementation, the display panel may include, but not limited to, any one of liquid crystal display (LCD) panel, an organic light-emitting diode (OLED) display panel, a light-emitting diode (LED) display panel, a quantum-dot LED (QLED) display panel, and a digital light processing (DLP) display panel. Certainly, the display panel may be another display panel, for example, a micro light-emitting diode (Micro LED) display panel, a mini light-emitting diode (Mini LED) display panel, a micro organic light-emitting diode (micro OLED) display panel or a liquid crystal on silicon (LCOS) display panel, or the like. A type of the display panel is not limited in the embodiments of the present disclosure, and any type may be set.

In an exemplary implementation, the first optical element is a microlens array, and each of microlenses may be a spheric lens, an aspheric lens, an optical path folding (Pancake) lens, or a Fresnel lens. A quantity and surface types of the microlenses are set according to software optimization.

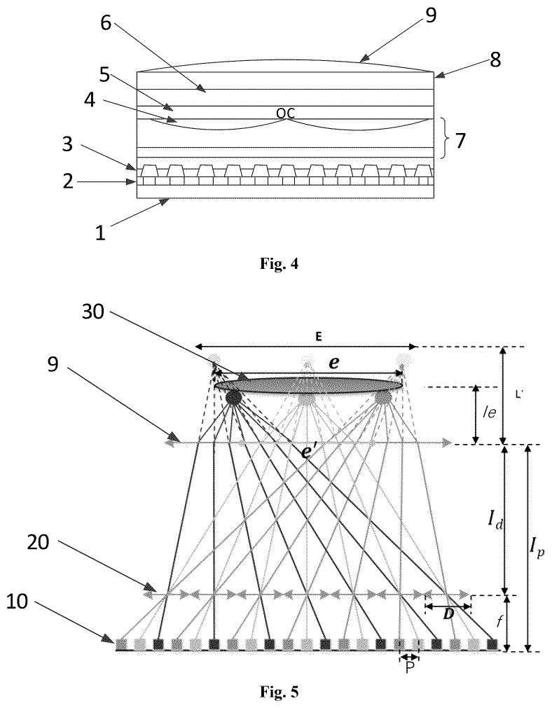

Referring to FIG. 3 and FIG. 4, in an exemplary implementation, the first optical element is a first cylindrical lens unit 4 and a second cylindrical lens unit 6 stacked in a light-emitting direction of the display panel, the first cylindrical lens unit 4 includes a plurality of cylindrical lenses arranged in a first direction, the second cylindrical lens unit 6 includes a plurality of cylindrical lenses arranged in a second direction, and an orthographic projection of the first direction on the display panel intersects with an orthographic projection of the second direction on the display panel.

For example, the first direction is perpendicular to the second direction, the cylindrical lenses in the first cylindrical lens unit 4 extend in a direction perpendicular to the first direction, and the cylindrical lenses in the second cylindrical lens unit 6 extend in a direction perpendicular to the second direction. For example, the first cylindrical lens unit 4 is used for collimating sub-pixels arranged in the first direction, and forms the virtual viewpoints that enable focusing with one eye. The second cylindrical lens unit 6 is used for collimating sub-pixels arranged in the second direction, and forms the virtual viewpoints that enable focusing with one eye.

In an exemplary implementation, the second optical element 9 is a lens, and the lens may be a spheric lens, an aspheric lens, an optical path folding (Pancake) lens, or a Fresnel lens.

In an exemplary implementation, the display panel is an OLED flexible display panel, and includes a base 1 made of a silicon material. A TFT array substrate 2 is disposed on the base 1, an RGB color light-emitting layer 3 is formed on the TFT array substrate 2, and an encapsulation layer 7 is disposed on a side of the light-emitting layer 3 away from the base 1. The first cylindrical lens unit 4, the second cylindrical lens unit 6, and the lens (i.e., the second optical element 9) are stacked on a side of the encapsulation layer 7 away from the base 1. An OC flat layer 5 is filled between the first cylindrical lens unit 4 and the second cylindrical lens unit 6. A transparent spacer layer 8 is disposed between the lens and the second cylindrical lens unit 6. The transparent spacer layer 8 may be made of transparent glass, but is not limited thereto. The lens may cover at least one cylindrical lens in the first cylindrical lens unit 4 and at least one cylindrical lens in the second cylindrical lens unit 6. For example, one lens is disposed in the light-field display apparatus. To be specific, the lens completely covers the first cylindrical lens unit 4 and the second cylindrical lens unit 6, but is not limited thereto.

For example, the second optical element 9 is a lens, and a focal length F of the lens is obtained by using the following formula:

$$tan \frac{FOV}{2} = \frac{\frac{PanelSize}{2}}{F} ,$$

where FOV is a field of view, and PanelSize is a width or a length of the display panel.

In an exemplary implementation, the field of view is 60 degrees, a size of the display panel is 0.9 inches (i.e., a length of a diagonal of the display panel=22.86 mm), and a width of the display panel in the first direction is 16.1 mm (i.e., PanelSize is 16.1 mm). Correspondingly, the focal length of the lens is 14 mm.

As can be learned from FIG. 5, the second optical element 9 converges the light rays emerging from the first optical element. A distance between a virtual viewpoint formed by the first optical element and the second optical element 9 is L′. A distance between a viewpoint in a human eye 30 formed by the second optical element and the second optical element is Ie. Clearly, L′ is greater than Ie, and it may be learned from FIG. 5 that a width of an area occupied by three virtual viewpoints formed by the first optical element is E, and a width of an area occupied by three viewpoints in the human eye 30 formed by the second optical element is e. Clearly, E is greater than e, of the lens is obtained by using the following formula: i.e., a distance between adjacent viewpoints is reduced, and a quantity of viewpoints in the human eye is increased, thereby improving resolution, and providing a larger depth of field.

For example, a field of view θ of each of microlenses or the cylindrical lenses satisfies the following formula:

$$tan \frac{θ}{2} = \frac{\frac{eyebox}{2}}{F} .$$

For example, an aperture of the microlens is D=n*p, where n is a quantity of viewpoints, and p is a sub-pixel spacing.

It needs to be noted that when the first optical element is the first cylindrical lens unit 4 and the second cylindrical lens unit 6 that are stacked, D is a width of the cylindrical lens in the first cylindrical lens unit 4 or the cylindrical lens in the second cylindrical lens unit 6.

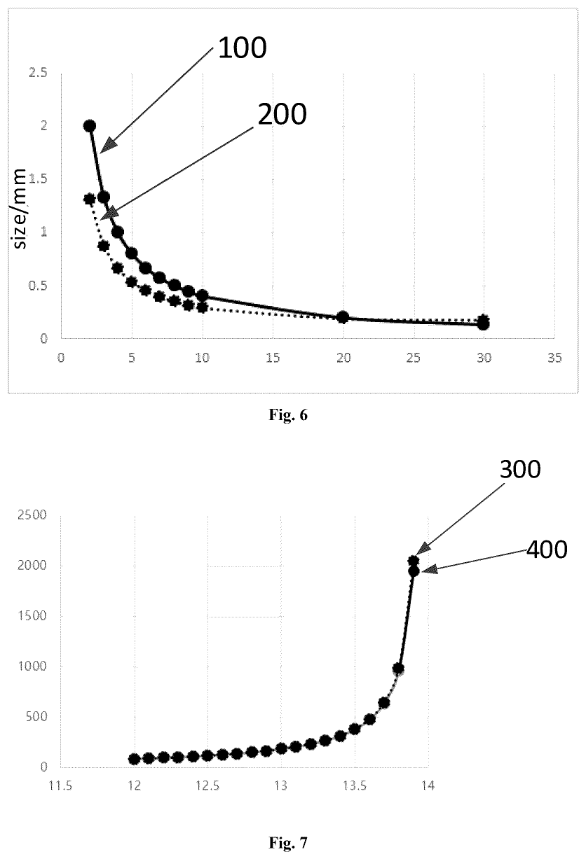

The display panel has a size of 0.9 inches and resolution of 3840*3840. Each of the sub-pixels on the display panel has a size of 2.8 μm*2.1 μm and a pixel aperture ratio of 30%. To provide as many viewpoints as possible in a single eye box (i.e., a tapered area between an optical display apparatus and an eyeball, and is also an area with the clearest display content) to provide a larger depth of field surface, it is necessary to ensure that a light spot of a single viewpoint in an eye is less than a distance between two adjacent light spots. In some implementations, the quantity of viewpoints optionally ranges from 2 to 20. Refer to FIG. 6. In FIG. 6, a horizontal coordinate denotes the quantity of viewpoints, a vertical coordinate denotes a numerical magnitude, a curve 100 denotes a magnitude of a distance between light spots in a human eye formed by adjacent viewpoints, and a curve 200 denotes a size of a light spot in the human eye formed by a viewpoint.

For example, the quantity of viewpoints formed by a single eye is 5, the focal length of the lens is 10 mm, and the eye box is 4 mm. The aperture of the microlens or the cylindrical lens is D=5*2.8=14 μm.

For example, a focal length f of the microlens is determined by using the following formula:

$$tan \frac{θ}{2} = \frac{\frac{D}{2}}{f} ,$$

where θ is the field of view of the microlens or the cylindrical lens, and D is the aperture of the microlens; and
a distance between the display panel and the microlens or the cylindrical lens is the focal length of the microlens or a focal length of the cylindrical lens.

It needs to be noted that when the first optical element is the first cylindrical lens unit 4 and the second cylindrical lens unit 6 that are stacked, the focal length f of the cylindrical lens in the first cylindrical lens unit 4 or the second cylindrical lens unit 6 is determined according to the foregoing formula:

$$tan \frac{θ}{2} = \frac{\frac{D}{2}}{f} ,$$

where θ is the field of view of the microlens or the cylindrical lens, and D is the width of the cylindrical lens.

For example, when the first optical element is a microlens array, a distance between a light-emitting surface of the display panel and the first optical element is the focal length of the microlens. When the first optical element is the first cylindrical lens unit 4 and the second cylindrical lens unit 6 that are stacked, a distance between the light-emitting surface of the display panel and the first cylindrical lens unit 4 disposed close to the display panel is a focal length of the first cylindrical lens unit 4.

It needs to be noted that when a medium between the display panel and the first optical element is air, a distance between the display panel and the first optical element is f. If the medium is not air, the distance between the display panel and the first optical element is 2f/n, where n is a refractive index of the medium.

In an exemplary implementation, the focal length f of the cylindrical lens in the first cylindrical lens unit 4 is 35 μm, the medium between the display panel and the first optical element is an optically clear (OC) adhesive, and a refractive index of the OC adhesive is 1.6.

For example, a radius of curvature of the cylindrical lens may be determined through the focal length of the cylindrical lens in the first cylindrical lens unit 4 or the second cylindrical lens unit 6, and an arch height of the cylindrical lens may be determined in combination with the aperture of the cylindrical lens. Details are as follows:

a material of a conventional common cylindrical lens has a refractive index of approximately 1.62. A formula of a focal length of a single lens is

$$\frac{1}{f} = ( n - 1 ) * [ \frac{1}{R 1} - \frac{1}{R 2} + ( n - 1 ) \frac{d}{nR 1 R 2} ] .$$

Only one side of the cylindrical lens has a curvature, and the other side is a flat surface, i.e., a radius R2 of curvature is infinite. A formula of a focal length of a single cylindrical lens may be simplified into r=f*Δn=35*0.62=21.7 μm. A radius r (i.e., R1) of curvature of the cylindrical lens is 21.7 μm.

If the aperture D of the cylindrical lens is 14 μm and the arch height is H=r−(r\hat{ }2−(D/2)\hat{ }2)\hat{ }0.5, the arch height of the cylindrical lens is 1.2 μm. It is set that a thickness of the flat layer 5 between the first cylindrical lens unit 4 and the second cylindrical lens unit 6 is 2 μm. An equivalent placement height of the second cylindrical lens unit 6 away from the display panel is a height of the second cylindrical lens unit 6+the thickness of the flat layer 5+an equivalent placement height of the first cylindrical lens unit 4=1.62*1.2+1.6*2+35=40.144 μm (the equivalent placement height of the first cylindrical lens unit 4 is 35 μm, a refractive index of the flat layer is 1.6, and a refractive index of the cylindrical lens in the second cylindrical lens unit 6 is 1.62). The equivalent placement height of the second cylindrical lens unit 6 is 40.144 μm.

For example, the second cylindrical lens unit 6 is optionally made of a material with a low refractive index, for example, a refractive index of 1.5. The aperture of the cylindrical lens in the second cylindrical lens unit 6 and the aperture of the cylindrical lens in the first cylindrical lens unit 4 are both 14 μm, and correspondingly, the radius of curvature is 20.072 μm, and the arch height is 1.26 μm. A calculation process is the same as above.

For example, a distance a (i.e., la in FIG. 5, and Ip in FIG. 5 denotes a distance between the lens and the display panel) between the first cylindrical lens unit 4 or the second cylindrical lens unit 6 and the lens satisfies the following formula:

$$\frac{1}{a} - \frac{1}{b} = \frac{1}{F} ,$$

where F is the focal length of the lens, b is a depth of field corresponding to the first cylindrical lens unit 4 or the second cylindrical lens unit 6, and a value of b ranges from 500 mm to 1500 mm.

It needs to be noted that because the first cylindrical lens unit 4 and the second cylindrical lens unit 6 are stacked, a distance between the first cylindrical lens unit 4 and the lens is different from a distance between the second cylindrical lens unit 6 and the lens. In this case, a depth of field surface obtained by modulating light rays by the first cylindrical lens unit 4 and a depth of field surface obtained by modulating light rays by the second cylindrical lens unit 6 need to be taken into consideration. To minimize a difference between the depth of field surface obtained by modulating light rays by the first cylindrical lens unit 4 and the depth of field surface obtained by modulating light rays by the second cylindrical lens unit 6, the depth of field optionally ranges from 500 mm to 1500 mm.

It is assumed that a distance between the lens and the second cylindrical lens unit 6 is a and a distance between the lens and the first cylindrical lens unit 4 is a′. When a difference between a and a′ is large, a distance between the first cylindrical lens unit 4 and the second cylindrical lens unit 6 is negligible. For example, a value of a ranges from 13.63 mm to 13.87 mm, and the difference between a and a′ is 5 μm, but is not limited thereto. FIG. 7 shows a relationship between the depth of field of the first cylindrical lens unit 4 and the distance between the first cylindrical lens unit 4 and the lens and a relationship between the depth of field of the second cylindrical lens and the distance between the second cylindrical lens unit 6 and the lens. In FIG. 7, a horizontal coordinate is the distance between the first cylindrical lens unit 4 or the second cylindrical lens unit 6 and the lens, and a vertical coordinate is the depth of field corresponding to the first cylindrical lens unit 4 or the second cylindrical lens unit 6. A curve 300 is the relationship between the depth of field of the second cylindrical lens unit 6 and the distance between the second cylindrical lens unit 6 and the lens, and a curve 400 is the relationship between the depth of field of the first cylindrical lens unit 4 and the distance between the first cylindrical lens unit 4 and the lens.

For example, when the second optical element 9 is a lens, an aperture of the lens is

$$D = tan \frac{FOV}{2} * eyerelief * 2 + eyebox + 27 mm .$$

Eye relief is a distance between an eye and the light-field display apparatus, and FOV is the field of view of the lens.

It may be understood that the above implementations are merely exemplary implementations for the purpose of describing the principles of the present disclosure. However, the present disclosure is not limited thereto. For a person of ordinary skill in the art, various variations and improvements may be made without departing from the spirit and substance of the present disclosure, and these variations and improvements are also considered to fall within the scope of protection of the present disclosure.

1. A light-field display apparatus, comprising:
a display panel, wherein the display panel is provided with a plurality of sub-pixels arranged in an array and is used for emitting a plurality of light rays having different image information respectively;
a first optical element, wherein the first optical element is located on a light-emitting side of the display panel and causes the plurality of light rays emitted by the display panel to form a plurality of virtual viewpoints that enable focusing with one eye; and
a second optical element, wherein the second optical element is provided on a side of the first optical element away from the display panel and is used for modulating light rays emerging from the first optical element to form a plurality of viewpoints in a human eye, to improve resolution of the viewpoints.

2. The light-field display apparatus according to claim 1, wherein the second optical element is a lens, a focal length F of the lens is obtained by using the following formula:
$$tan \frac{FOV}{2} = \frac{\frac{PanelSize}{2}}{F} ,$$
wherein FOV is a field of view, and PanelSize is a length of a diagonal of the display panel.

3. The light-field display apparatus according to claim 2, wherein the lens is a spheric lens, an aspheric lens, an optical path folding lens, or a Fresnel lens.

4. The light-field display apparatus according to claim 2, wherein the first optical element comprises a microlens array;
or,
wherein the first optical element comprises a first cylindrical lens unit and a second cylindrical lens unit stacked in a light-emitting direction of the display panel, the first cylindrical lens unit comprises a plurality of cylindrical lenses arranged in a first direction, the second cylindrical lens unit comprises a plurality of cylindrical lenses arranged in a second direction, and an orthographic projection of the first direction on the display panel intersects with an orthographic projection of the second direction on the display panel.

5. (canceled)

6. The light-field display apparatus according to claim 4, wherein a field of view θ of each microlens in the microlens array or a field of view θ of the cylindrical lenses satisfies the following formula:
$$tan \frac{θ}{2} = \frac{\frac{eyebox}{2}}{F} .$$

7. The light-field display apparatus according to claim 6, wherein an aperture of the microlens is D=n*p, wherein n is a quantity of viewpoints, and p is a sub-pixel spacing.

8. The light-field display apparatus according to claim 7, wherein a focal length f of the microlens is determined by using the following formula:
$$tan \frac{θ}{2} = \frac{\frac{D}{2}}{f} ,$$
wherein θ is the field of view of the microlens, and D is the aperture of the microlens;
a distance between the display panel and the microlens or the cylindrical lens is the focal length of the microlens or a focal length of the cylindrical lens.

9. The light-field display apparatus according to claim 4, wherein a distance a between the first cylindrical lens unit or the second cylindrical lens unit and the lens satisfies the following formula:
$$\frac{1}{a} - \frac{1}{b} = \frac{1}{F} ,$$
wherein F is the focal length of the lens, b is a depth of field corresponding to the first cylindrical lens unit or the second cylindrical lens unit, and a value of b ranges from 500 mm to 1500 mm.

10. The light-field display apparatus according to claim 1, wherein a diameter of a single one of the viewpoints is less than a distance between two adjacent viewpoints.
